(19) United States
(12) Patent Application Publication
(10) Pub. No.: US 2017/0181812 A1
(43) Pub. Date: Jun. 29, 2017

(54) Ornament for Attachment to Orthodontic Braces

(71) Applicant: Tracy Ramsay, Wichita, KS (US)

(72) Inventor: Tracy Ramsay, Wichita, KS (US)

(21) Appl. No.: 15/455,975

(22) Filed: Mar. 10, 2017

(51) Int. Cl. A61C 7/12

(52) U.S. Cl. CPC A61C 7/12

(57) ABSTRACT

An ornament for attachment to orthodontic braces, the orthodontic braces having an arch wire overlying a laterally adjacent pair of teeth, the ornament having a web having a front end and a rear end; the ornament further having a first arm fixedly attached to and extending downwardly from the web's front end; the ornament further having a second arm fixedly attached to and extending downwardly from the web's rear end; the ornament further having a channel bounded by structures including the web, the first arm, and the second arm, the channel being fitted for, upon a passage of the arch wire between the first and second arms, nestingly receiving the arch wire.

### FIELD OF THE INVENTION

This invention relates to orthodontic braces. More particularly, this invention relates ornaments which are attachable to orthodontic braces.

### BACKGROUND OF THE INVENTION

Children and young teens having misaligned and improperly spaced front teeth are commonly fitted by an orthodontist with metal braces which comprise a lateral arch wire spanning between and interconnecting a series of tooth anchored wire mounting brackets. Such braces are commonly adapted for pulling, pushing, and progressively straightening and aligning the misaligned teeth. Many children and young teens may view the brackets, connectors, and wires utilized in forming such braces as ugly and unsightly, and such negative views often undesirably cause anguish, self-consciousness, and embarrassment. Such negative self-confidence and self esteem issues relating to wearing braces may undesirably hinder the braces' performance of their basic functions which include heightening self-confidence by ultimately improving a child or teen's facial appearance.

Small braces ornaments are known to be attached to braces arch wires for improving the appearance of the braces. However, such ornaments are typically difficult to install, they are unstable and loose fitting, they are prone to unwanted and accidental de-installations, and they tend to undesirably capture and retain food debris.

The instant invention solves or ameliorates the braces ornamentation related problems, defects, and deficiencies described above by providing an ornament for attaching to orthodontic braces which incorporates specially configured arms and channels which include multiple adaptations for securely receiving a brace's arch wire, for providing stabilizing contacts with adjacent teeth, for locking the ornament against accidental de-installations, and for resisting accumulations of food debris.

### BRIEF SUMMARY OF THE INVENTION

The instant inventive ornament is preferably utilized for attachment to orthodontic braces of the type which include a laterally extending arch wire which spans between and interconnects a series of tooth mounted wire engaging brackets. In the preferred embodiment and in a preferred mode of use of the instant invention, such arch wire frontwardly overlies a pair of adjacent teeth selected from the group consisting of upper central incisors, upper lateral incisors, and upper canines. In the preferred embodiment, such arch wire is anchored in a forwardly overlying position with respect to such upper teeth by the wire engaging brackets.

A first structural component of the instant inventive ornament comprises a web having a front end and a rear end. In the preferred embodiment, the web component of the ornament constitutes a structurally upper portion which, upon installation of the ornament in engagement with a braces arch wire, overlies and downwardly hooks against the arch wire. In the preferred embodiment, the lower end or lower surface of the web component is closely shaped and fitted to nestingly engage and seal against the typically curved or orthogonal upper end of the lateral arch wire.

A further structural component of the instant inventive ornament comprises a first arm or front arm which is fixedly attached to and extends downwardly from the web's front end. Where the web and the first arm components are composed of a durable and flexible plastic material, as is preferred, such fixed attachment preferably comprises a whole or continuous formation of the upper end of the first arm with the front end of the web.

A further structural component of the instant inventive ornament comprises a second arm which, like the first arm, is fixedly attached to and extends downwardly from the web's rear end. In the preferred embodiment, the second arm is positioned immediately rearwardly from the first arm, and the ornament's combination of components including the web, the first arm, and the second arm, functionally form a downwardly opening “C” clip or “C” bracket.

A further structural component of the instant inventive ornament comprises a first channel or wire receiving channel which preferably extends laterally through the ornament. The first channel is preferably bounded and defined in three directions: upwardly by the web, forwardly by the first arm, and rearwardly by the second arm. In the preferred embodiment, the first channel is fitted for, upon a downward extension of the ornament over a braces arch wire resulting in a passage of the arch wire between the first and second arms, nestingly receiving the arch wire. To achieve such close fitting nesting receipt, the cross-sectional shape of the first channel is preferably circular or rectangular, and includes inside dimensions matching the outside diameter or dimensions of a common arch wire upon which the ornament may be installed. Braces arch wires typically have a circular diameter or rectangular cross-sectional dimensions ranging between 0.30 mm and 0.64 mm, and the fitting of the first channel preferably closely matches such arch wire shapes and sizes.

A further preferred structural component of the instant inventive ornament for attachment to orthodontic braces comprises a third arm which is fixedly attached to or wholly formed with a rearward surface of the second arm. In a preferred embodiment, the third arm component is fitted so that upon an installation of the ornament over a braces arch wire, the rearwardly extending distal end of the third arm contacts and biases against a pair of adjacent teeth in an ornament stabilizing manner. While the third arm component may suitably comprise a longitudinal thickening of the second arm component, which thickening effectively utilizes the second arm's rear face as a third arm distal end, the third arm is preferably configured to present left and right tooth contacting faces. In the preferred embodiment, such third arm faces are angled and positioned for stabilizing biasing contacts with the walls of the “V” or valley which is naturally formed at adjacent lateral ends of the adjacent teeth.

The instant inventive ornament may suitably further comprise a fourth arm which is configured and attached similarly with the angled faces configuration of the third arm. Where a fourth arm is provided, it is preferably positioned vertically downwardly from the third arm to form a second channel or debris clearance channel which opens rearwardly from the ornament. In the event that a gap is formed between the adjacent teeth which underlie the ornament, such second rearwardly opening channel (formed via provision of the fourth arm) may advantageously communicate with such tooth gap to facilitate rinsing and washing of debris from between the teeth while the ornament remains in place.

In a preferred embodiment of the instant inventive ornament, the respective front and rear surfaces of the second and first arms are positioned for close and abutting or sealing contact with each other for prevention of ingress of food debris within the ornament's downwardly opening “C” bracket space. Also, in a preferred embodiment, the overall shape of the ornament is cylindrical having various geometric shape or object silhouetting cross-sections. Such preferred cylindrical cross-sectional shaping of the ornament advantageously adapts the front surface of the front arm component to present an aesthetically pleasing sculptural image.

In use of the instant inventive ornament, a child may easily decorate his or her orthodontic braces by downwardly snapping one of the inventive ornaments over an arch wire section which spans between a pair of the braces' brackets. Upon such snap-on installation, the ornament's rearwardly extending third and/or fourth arms advantageously bias against the rearwardly underlying teeth for stabilizing the ornament. During wearing of the ornament, the preferred abutting contacts of the front and rear surfaces of the second and first arms advantageously prevent incursions of food debris within the ornament.

Accordingly, objects of the instant invention include the provision of an ornament for attachment to orthodontic braces which incorporates structures, as described above, and which arranges those structures in relation to each other in manners described above, for the achievement of beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a rear perspective view of a preferred embodiment of the instant inventive ornament.

FIG. 2 presents an alternate front perspective view of the ornament of FIG. 1, the view showing the invention installed upon teeth mounted orthodontic braces.

FIG. 3 is a sectional view as indicated in FIG. 2.

FIG. 4 is an alternative sectional view as indicated in FIG. 2.

FIG. 5 presents an alternate configuration of the structure depicted in FIG. 1.

FIG. 6 is an alternate sectional view as indicated in FIGS. 2 and 5.

FIG. 7 presents an alternate configuration of the structure depicted in FIG. 1.

FIG. 8 presents a further alternate configuration of the structure depicted in FIGS. 1 and 7.

### DETAILED DESCRIPTION OF PREFERRED EMBODIMENTS

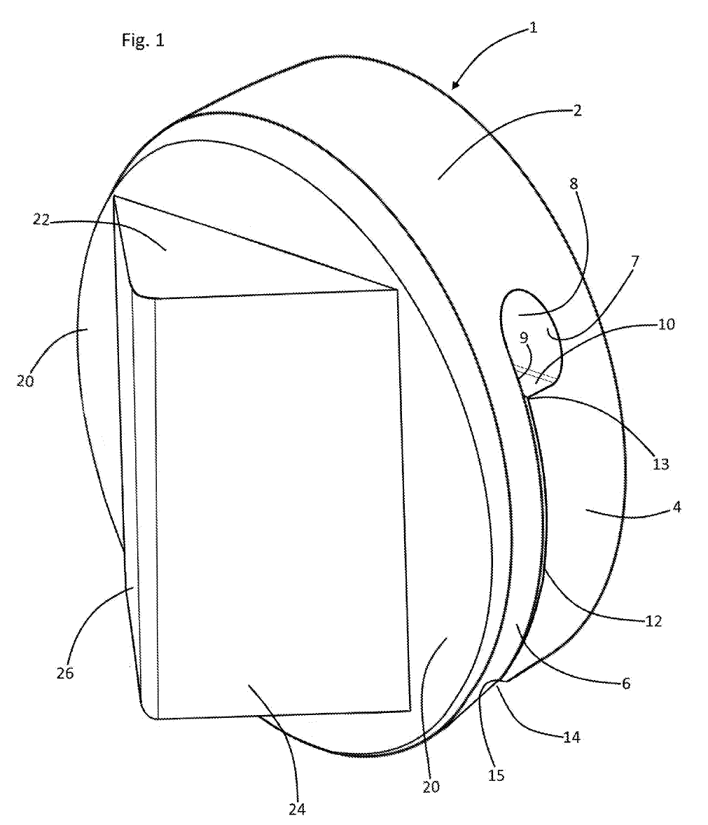

Referring now to the drawings, and in particular to Drawing FIG. 1, a preferred embodiment of the instant inventive ornament for attachment to orthodontic braces is referred to generally by Reference Arrow 1. The ornament 1 has an upper web component 2 which, like all other components of the instant inventive ornament, is preferably composed of a durable, flexible, and elastic plastic material.

A first arm or front arm component 4 has its upper or proximal end fixedly attached to or formed wholly with the lower and forward end of the web 2. A rear arm or second arm component 6 similarly is fixedly attached to and extends distally or downwardly from the lower and rearward end of the web 2. A first channel or wire channel component 8 extends laterally through the ornament 1, such channel comprising a bore which is bounded and formed by the lower aspect of the web 2, by the proximal and rearward aspect of the first arm 4, and by the proximal and frontward aspect of the second arm 6.

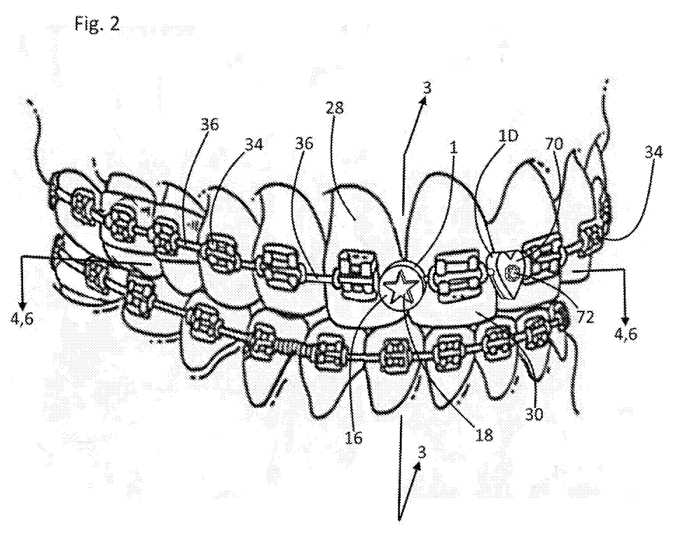

Referring to FIGS. 1 and 2, orthodontic braces having brackets 34 and having a laterally extending arch wire 36 are depicted. In the preferred embodiment of the instant invention, the first channel 8 is closely fitted for nestingly and securely receiving and sealing against the arch wire 36.

The lower or distal ends of arms 4 and 6 preferably form a wire insertion assisting “V” channel 14 having an upper vertex 15. To install the instant inventive ornament 1, a wearer of the orthodontic braces depicted in FIG. 2 may initially grasp the ornament 1 between his or her thumb and index finger, and may position the ornament so that its “V” channel 14 directly overlies a section of the arch wire 36 which spans between an adjacent pair of brackets 34. Thereafter, the wearer may downwardly drive the ornament 1 against arch wire 36. Upon such downward driving, the arch wire 36 enters “V” channel 14 in alignment with the vertex 15. Further downward driving against the ornament 1 caused the wire 36 to temporarily act as a mandrel which flexibly splays arms 4 and 6 longitudinally away from each other. Such arm splaying allows for a relative upward passage of the arch wire 36 within the “C” space which is formed by the web 2 and arms 4 and 6. Such downward driving and arm splaying preferably continues until the arch wire 36 snaps into place within the first channel 8.

In a preferred embodiment of the instant invention, the lower end of the first channel 8 comprises a substantially horizontal wire locking floor 10 which, in combination with the rear wall 9 of the channel 8, forms a second “V” channel. In the preferred embodiment, such second “V” channel 9,10 is configured for performing a wire extraction resisting function.

To facilitate performance of such wire extraction resisting function, the vertex 13 of the second “V” channel 9,10 is preferably positioned at the rearward end of the floor 10. Such rearward vertex positioning accommodates for circumstances where objects such as the braces wearer's tongue, fingertips, or food items unintentionally come into impinging contact with the ornament 1. When the ornament 1 is worn, it is rearwardly shielded by the wearer's teeth, assuring that impinging contacts against the ornament cannot emanate from any rearward position. Where impinging contacts emanate from an upper and forward direction relative to the teeth, the contacts tend to hold the ornament 1 at its installed position upon the arch wire 36, such contacts threatening no accidental de-installations of the ornament. Where an impinging contact emanates form the lower and forward direction, and where an ornament lacks the installation maintaining features of the instant invention, such contact may produce an undesirable or accidental de-installation of the ornament. The instant invention's rearward placement of the vertex 13 as indicated in FIG. 1, minimizes such de-installation threat by assuring that any upward and rearwardly directed impinging contact presses the floor 10 and the front wall 7 of the channel 8 against the lower/front side of arch wire 36, and by assuring that such contact biases the wire 36 away from the vertex 13 of the “V” channel 9,10. The bias away from vertex 13 advantageously resists any tendency of the arch wire 36 to unintentionally act as an arms splaying mandrel. Accordingly, the channel component 8, including its special extraction resisting “V” channel 9,10,13, protects against unintentional or accidental de-installations of the ornament.

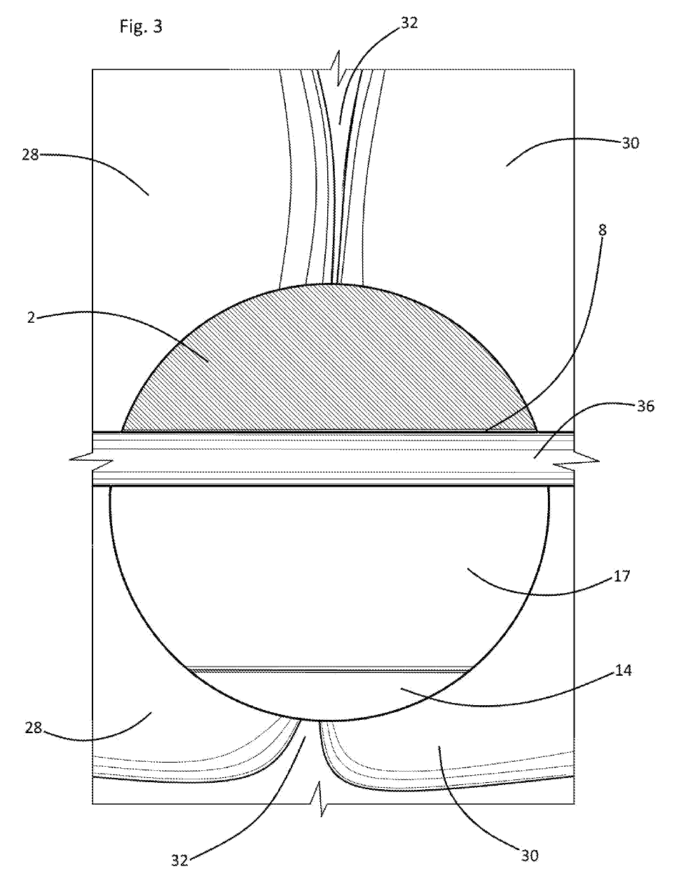

In the preferred embodiment, referring to FIG. 3, the front face 17 of the second arm 6, and the rear face 12 of the first arm 4 are closely positioned and aligned for abutting contact. Upon installation of the ornament 1 as indicated in FIG. 2, such abutting contact advantageously prevents accumulations of food debris within the interior “C” channel spaces of the ornament.

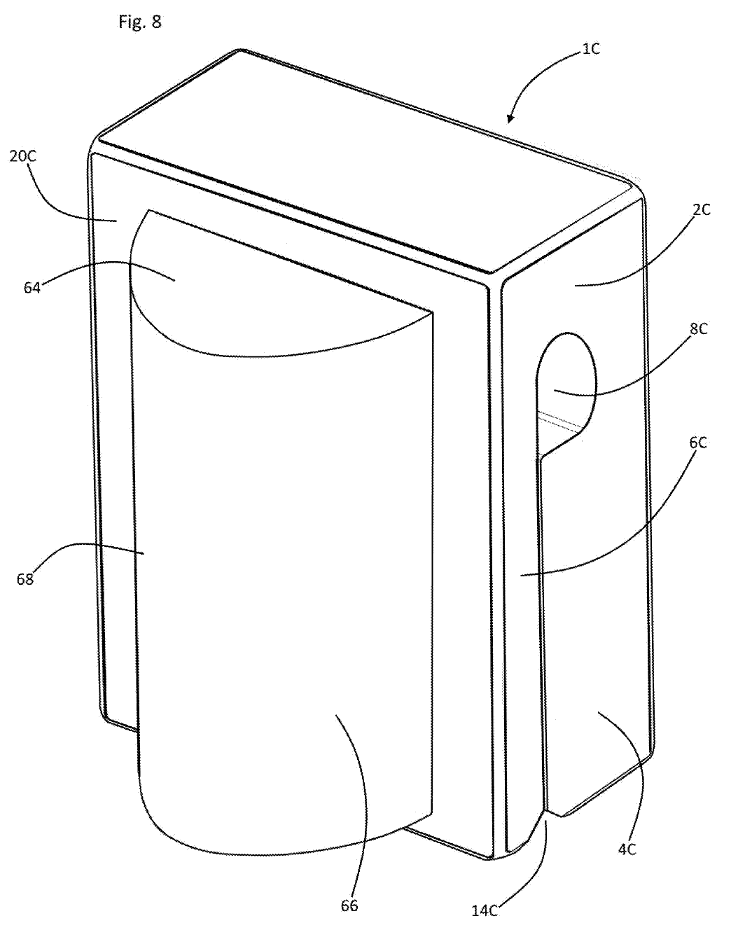

Referring to FIGS. 1-4, and 8 the instant inventive ornament preferably further comprises a third arm 22 which is fixedly attached to or is formed wholly with the rear face or rear end 20 of the second arm 6. In the preferred embodiment, the invention's rearwardly extending third arm 22 forms angled right and left faces 24 and 26. Referring particularly to FIG. 8's structural alternative, third arm 64 may alternatively form curved right and left faces 66 and 68. Upon an installation of the ornament 1, or 1C as the case may be, the arch wire 36 nests within channel 8,8C, while the third arm 22 or 64 extends rearwardly for biasing and stabilizing contact with laterally adjacent upper incisor or canine teeth 28 and 30.

Upon such ornament installation, the third arm's angled right face 24 or 66 biases and against and frictionally deforms around tooth 28, while the left angled face 26 or 68 similarly presses and deforms against tooth 30. In their installed positions, the third arm 22 or 64 functions as an anchoring member which spans across the naturally formed “V” space or channel 32 between teeth 28 and 30. As a result of its engagement with “V” channel 32, the ornament 1, 1C is advantageously stabilized, and is frictionally held in place against any unwanted or accidental de-installation. Such frictional resistance against de-installation works in conjunction with the de-installation resisting positioning of vertex 13, discussed above, to provide enhanced protection against accidental removal of the ornament 1. The molded contacts of arm faces 24 and 26 (or 66 and 68) with teeth 28 and 30 may further advantageously function as a seal against accumulations of food debris.

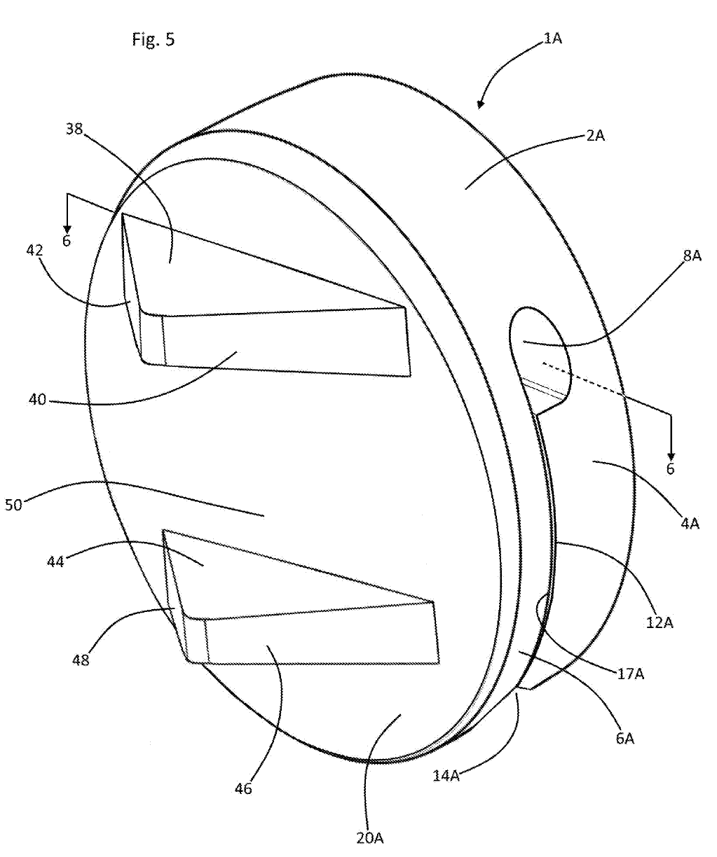

Referring simultaneously to FIGS. 1 and 4-6, each structure of FIG. 5 which is identified by a reference numeral having the suffix “A” is configured similarly with similarly numbered structures appearing in FIG. 1. Comparison of the structures of FIG. 1 and FIG. 5 shows that the vertical dimension of FIG. 1's third arm 22 may be reduced to the lesser vertical dimension of FIG. 5's third arm 38, such alternatively configured third arm 38 having, similarly with third arm 22, right and left tooth biasing faces 40 and 42. In the FIG. 5 structural alternative, an underlying fourth arm 44 is configured similarly with the overlying third arm 38, such fourth arm 44, like the third arm 38, having right and left faces 46 and 48 and extending rearwardly from the rear face 20A of the rear arm 6A.

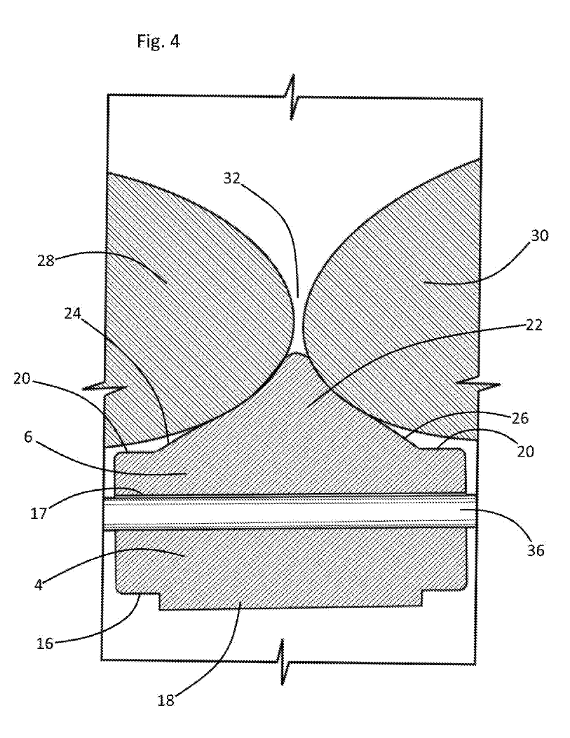

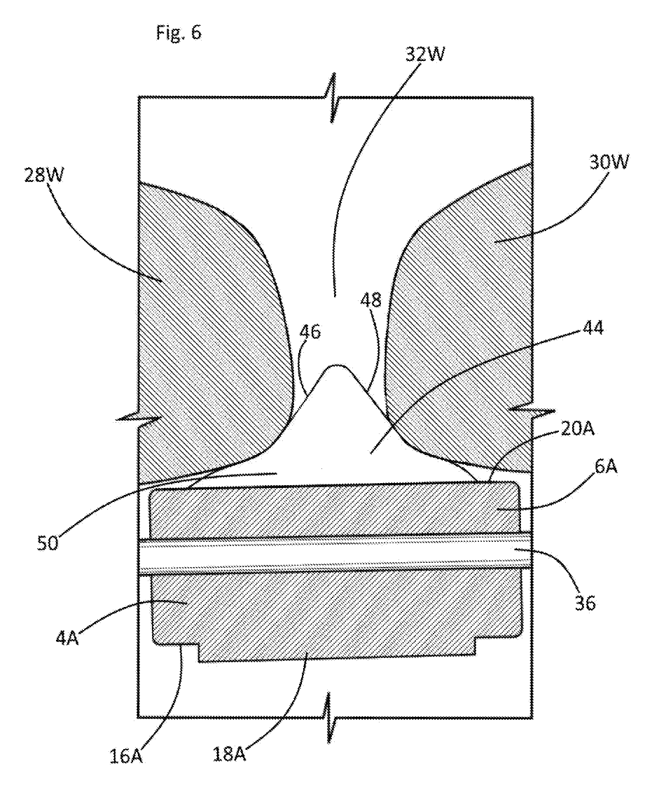

In the FIG. 5 alternative embodiment, the fourth arm 48 is displaced vertically downwardly and away from the third arm 38 to form a second channel or debris clearance channel 50 which extends laterally and opens rearwardly from the rear face 20A of the rear arm 6A. As is particularly shown in FIG. 6, an alternative tooth valley or gap 32W is wider than the gap 32 depicted in FIGS. 3 and 4. A frontwardly overlying positioning of FIG. 1's vertically continuous “V” member or third arm 22 at such widened gap 32W may undesirably create an occluded space within which food debris may be trapped. The alternative second channel 50 of the ornament 1A which is formed by the alternatively configured third and fourth arms 38 and 44 may accommodate for such undesirable food debris trapping by allowing the food debris to be washed or rinsed through gap 32W with flow communicating with channel 50. Compacting and accumulation of food debris within gap 32W is advantageously prevented by the positioning of ornament gap 50 over and in communication with the tooth gap 32W.

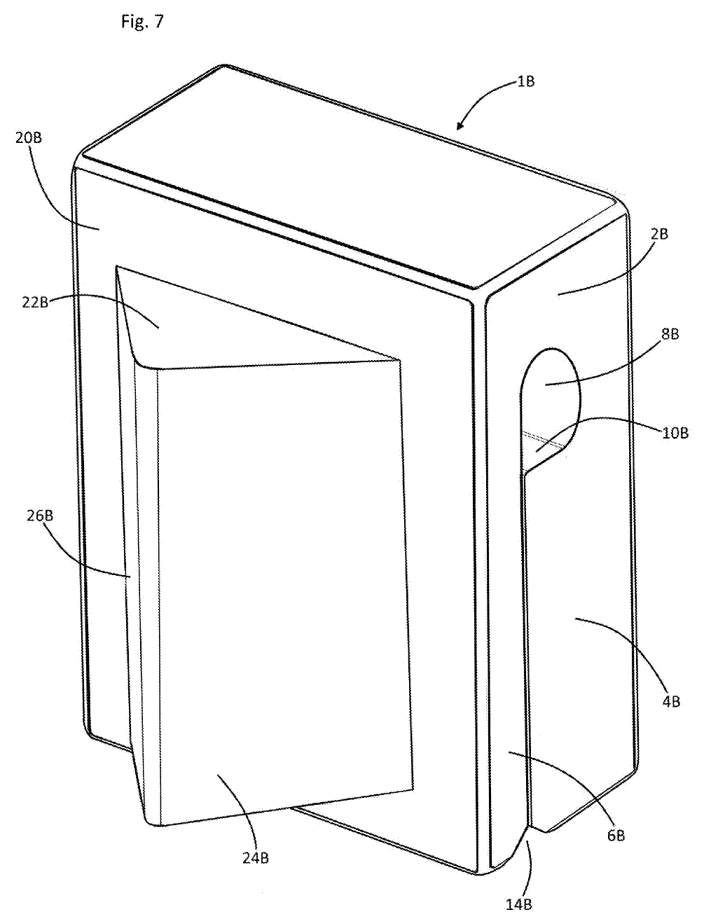

Each of the ornaments 1, 1A, 1B, 1C, and 1D shown in Drawing FIGS. 1, 2, 5, 7, and 8 shares a common cylindrical three dimensional geometry with each other ornament, with ornaments 1 and 1A representing circular cylinders, with ornaments 7 and 8 representing cylinders having a square or rectangular cross-sectional shapes, and with ornament 1D representing cylinders having heart cross-sectional shapes. Such cylindrical cross-sectional shapes of the inventive ornament advantageously configure the front surfaces of the web and first arm components (e.g., surfaces 16 and 70 of ornaments 1 and 1D) to aesthetically and sculpturally silhouette various objects and shapes. The circular cross-sections of ornaments 1 and 1A are further representative of elliptical and oval shapes. The rectangular cross-sections of ornaments 1B and C are similarly intended to be representative of other regular and irregular polygonal shapes such as diamond shapes, pentagons, and hexagons. The heart shape of ornament 1D is further representative of a multitude of items, objects, and symbols (such as a mouse head with rounded ears, other animals, and animal heads, star shapes, and vehicles) which may be sculpturally presented by their cylindrical cross-sections.

The star shaped protrusion 18 which extends from the front surface 16 of ornament 1 is similarly representative of a multitude of items, objects, and symbols which may constitute a bold relief sculptural depicting member. Alternatively, a second ornament, such as a small cubic zirconia gem 72 may be attached to the first ornament's front surfaces.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

1. An ornament for attachment to orthodontic braces, the orthodontic braces having an arch wire overlying a laterally adjacent pair of teeth, the ornament comprising:
(a) a web having a front end and a rear end;
(b) a first arm fixedly attached to and extending downwardly from the web's front end;
(c) a second arm fixedly attached to and extending downwardly from the web's rear end; and
(d) a first channel upwardly bounded by the web, the first channel being frontwardly and rearwardly bounded by the first and second arms, the first channel being fitted for, upon a passage of the arch wire between the front and rear arms, nestingly receiving the arch wire.

2. The ornament for attachment to orthodontic braces of claim 1 further comprising at least a third arm fixedly attached to and extending rearwardly from the second arm's rear end, the at least third arm being fitted for, upon the first channel's nesting receipt of the arch wire, biasing against the laterally adjacent pair of teeth.

3. The ornament for attachment to orthodontic braces of claim 2 wherein the at least third arm has left and right faces, the biasing of the at least third arm against the laterally adjacent pair of teeth comprising a contact of the left face against one of said teeth, and comprising a contact of the right face against the other of said teeth.

4. Then ornament for attachment to orthodontic braces of claim 3 further comprising a fourth arm fixedly attached to and extending rearwardly from the second arm, the fourth arm being fitted for, upon the first channel's nesting receipt of the arch wire, biasing against the laterally adjacent pair of teeth.

5. The ornament for attachment to orthodontic braces of claim 4 further comprising a second channel, the second channel being frontwardly bounded by the second arm, the second channel being upwardly and downwardly bounded by the at least third and fourth arms.

6. The ornament for attachment to orthodontic braces of claim 5 wherein the web, and each of the arms are composed of plastic.

7.
The ornament for attachment to orthodontic braces of claim 1 wherein the first arm has a rear surface, wherein the second arm has a front surface, and wherein the second arm is positioned for, upon the first channel's nesting receipt of the arch wire, contacting its front surface with the first arm's rear surface.

8. The ornament for attachment to orthodontic braces of claim 1 wherein the first channel has a wire locking floor having a rear end.

9. The ornament for attachment to orthodontic braces of claim 8 wherein the first channel has a rear wall, and further comprising an extraction resisting “V” channel, said channel being respectively rearwardly and downwardly bounded by said rear wall and the wire locking floor.

10. The ornament for attachment to orthodontic braces of claim 9 wherein the extraction stopping “V” channel has a vertex positioned at the wire locking floor's rear end.

11. The ornament for attachment to orthodontic braces of claim 1 wherein the first and second arms have distal ends, and further comprising an insertion assisting “V” channel positioned at said arms' distal ends.

12. Then ornament for attachment to orthodontic braces of claim 1 wherein the first arm has a front end, and wherein the front ends of the web and the first arm adapted for silhouetting a shape selected from the group consisting of circles, ellipses, ovals, squares, rectangles, regular polygons, irregular polygons, and hearts, stars, animals, and vehicles.

13. The ornament for attachment to orthodontic braces of claim 12 wherein the first arm has a front surface, and further comprising a bold relief sculptural depicting member fixedly attached to said front surface.

14. The ornament for attachment to orthodontic braces of claim 12 wherein the first arm has a front surface, and further comprising a second ornament fixedly attached to said front surface.
